(19) United States
(12) Patent Application Publication
(10) Pub. No.: US 2025/0265519 A1
(43) Pub. Date: Aug. 21, 2025

(54) SYSTEMS FOR AND METHODS OF LEARNING FOR ON-DEMAND OPTIMAL ELECTRIC VEHICLE (EV) FLEET OPERATION

(71) Applicant: AV-Connect, Inc., Alameda, CA (US)

(72) Inventors: Xu Shen, Emeryville, CA (US); Bruce Wootton, Alameda, CA (US); Jacopo Guanetti, Berkeley, CA (US)

(21) Appl. No.: 19/054,834

(22) Filed: Feb. 15, 2025

Related U.S. Application Data
(60) Provisional application No. 63/554,835, filed on Feb. 16, 2024.

(51) Int. Cl. G06Q 10/0631; G06Q 10/04; G06Q 10/0639; G06Q 10/067; G06Q 50/40

(52) U.S. Cl. CPC G06Q 10/06312; G06Q 10/04; G06Q 10/06315; G06Q 10/06393; G06Q 10/067; G06Q 50/40

(57) ABSTRACT

Systems and methods for optimizing on-demand electric vehicle and mixed-fuel fleet operations use a learning-based system. In some embodiments, the method includes collecting real-time operational data, simulating service and charging processes, formulating assignment strategies, and adjusting assignments based on cost-to-go predictions in real time. The assignment strategy is updated in real time to account for parameters such as states of charge on the vehicles; changing context, such as weather or traffic; historical data; and constraints.

### RELATED APPLICATION(S)

This application claims priority under 35 U.S.C. § 119 (e) of the co-pending U.S. Provisional Patent Application Ser. No. 63/554,835, filed Feb. 16, 2024, and titled “Learning System for On-Demand Optimal Electric Vehicle (EV) Fleet Operation,” which is hereby incorporated by reference in its entirety.

### FIELD OF THE INVENTION

The present invention is directed to vehicle fleet management systems. More specifically, the present invention is directed to systems for and methods of optimizing the operation of on-demand electric vehicle (EV) fleets through machine learning and predictive modeling.

### BACKGROUND OF THE INVENTION

Fleets of vehicles are used in a variety of environments, such as roadside assistance services, to charge a customer's battery or fix a flat tire; ride hailing/sharing services, such as Uber® and Lyft®; transporting material between locations at construction sites; and delivering parts in factories and other environments, all of these services provided on-demand, to name only a few such uses.

Typically, when vehicles are dispatched to respond to a service request, the vehicles are assigned to the requests in a manner to reduce the customer wait time. Often, this means that a system servicing requests will assign a vehicle closest to the customer making the request. These systems do not consider the limited range of electric vehicles and therefore do not dynamically account for changing circumstances to optimize the operation of the entire fleet, while keeping customers satisfied.

There is a need for systems and methods that adaptively optimize fleet operations in real-time, considering dynamic factors such as limited EV range and charging demand.

### BRIEF SUMMARY OF THE INVENTION

In accordance with embodiments of the disclosure, systems and methods optimize on-demand operation of an EV fleet by dynamically optimizing vehicle assignments, charging schedules, and routing based on real-time data inputs.

These systems and methods are designed to enhance fleet operations by integrating real-time data, predictive modeling, and optimization strategies. The systems and methods dynamically allocate vehicles from a fleet of vehicles to service requests and charge at depot charging stations by considering, for example, the proximity of available vehicles to service requests, service urgency, prioritization, current battery levels, and estimated remaining service capacity.

By leveraging traffic data, weather conditions, and historical patterns, these systems and methods accurately forecast expected travel time from origin to destination and energy consumption for EVs, ensuring vehicles have sufficient charge to complete assignments without disruptions, and depot charger availability and expected wait times.

In some embodiments, the systems and methods consider dynamic factors such as vehicle locations, traffic/road/weather conditions from the vehicles to the service locations (e.g., a route having steep inclines and traffic signals may require more charge and take longer), vehicle charge, locations of charging stations, requirements (e.g., some customers require a vehicle capable of towing a truck or equipped to provide gasoline or an electric charge), to name only a few examples. Typically, the factors change in real time, requiring the optimization algorithms producing outputs that also change in real time. As one example, at a time Tₒ, service requests A, B, and C will optimally be serviced by vehicle V₁ in the order A, B, C, D, E. However, based on changing/updated factors, at a time T₁ later than Tₒ, the remaining requests will be serviced by V₁ in the order D, C, and by vehicle V₂ in the order B, E. In other words, in certain situations, the sequence of servicing requests will be reshuffled. In some embodiments, this resequencing is performed by a Micro-Level Simulator and Model Predictive Controller.

In accordance with embodiments, a learning-based system for the on-demand operation of an EV fleet dynamically optimizes vehicle assignments, charging schedules, and routing based on real-time data inputs.

In some embodiments, the system first collects real-time data on service demand, fleet status, traffic conditions, and weather. The simulator uses this data to predict the results of different assignment strategies. An assignment strategy formulator then generates optimal task assignments for vehicles, which are adjusted in real-time based on predictions from a cost-to-go model (described below) to respond to changing conditions dynamically.

In some embodiments, the system includes a micro-level simulator, a Model Predictive Control (MPC) problem formulation, and a Deep Reinforcement Learning (DRL)-based cost-to-go prediction model to efficiently manage fleet operations, thereby reducing service response times, maximizing vehicle utilization rates, and minimizing operational costs.

In a first aspect a method of optimally assigning on-demand vehicles in a fleet of vehicles includes collecting real-time data for vehicles in the fleet of vehicles; simulating service and charging processes for the vehicles; determining assignment strategies for the vehicles to service one or more service requests through model predictive control (MPC); and adjusting assignments based on cost-to-go predictions from a deep reinforcement learning (DRL) model. In some embodiments, the data comprise telemetrics data, operational data, context, or any combination thereof. In some embodiments, the fleet of vehicles comprises electric vehicles, including human-operated vehicles, automated vehicles, or both. In some embodiments, the assignment strategies are determined through model predictive control. In some embodiments, the cost-to-go predictions are determined from a deep reinforcement learning model (DRL). In some embodiments, the DRL model evaluates an effectiveness of different vehicle assignment strategies under varying operational conditions. In some embodiments, the assignments are based on an assignment algorithm, wherein adjusting the assignments comprises solving an optimization problem. In some embodiments, the optimization problem has associated constraints, costs, or both.

In some embodiments, the cost-to-go predictions are based on a cost-to-go model that incorporates one or more factors including vehicle state of charge (SOC), traffic conditions, and predicted service demand. In some embodiments, the constraints and cost-to-go model include driver status and labor rules so that the assignment maximizes driver utilization while meeting the labor rules.

In some embodiments, the factors include a context, the context comprising traffic conditions, weather conditions, a frequency of past service requests within a predetermined distance of a customer location, or any combination thereof.

In a second aspect, a system for optimizing on-demand fleet operations for a fleet of vehicles includes a learning-based predictor (LBP) configured to predict energy consumption usage for each vehicle in the fleet of vehicles for service trips; a dispatcher coupled to the LBP, the dispatcher configured to receive service requests and assign the service requests to the vehicles to optimize parameters for servicing the service requests; a learning-based cost-to-go (LBCG) module coupled to the LBP and the dispatcher, the LBCG module configured to maximize long-term performance of the fleet of vehicles for the service trips; and a vehicle simulator coupled to the dispatcher and the LBCG, the vehicle simulator configured to simulate the functioning of the vehicles and transmit output and parameters to the LBCG.

In some embodiments the system also includes a service database storing service requests. The service database is coupled to the dispatcher, such that when a service is added to or deleted from the service database, the optimal assignment module is updated. In some embodiments, the system also includes a queue database storing unassigned services. The entries in the queue database trigger updating the optimal assignment module. In some embodiments, the vehicle simulator generates key performance indicators transmitted to the LBCG.

In some embodiments, the system also includes a Depot module coupled to the vehicle simulator. The Depot module stores states of charging queues and states of charging in a depot.

In some embodiments, the vehicle simulator includes a finite state machine for monitoring transitions between states for the vehicles. The states include one or more of IDLE, DRIVE, SERVICE, CHARGE, and CHARGING QUEUE.

In some embodiments, one or more of components include the LBP, the dispatcher, the LBGC. The vehicle simulator includes a corresponding computer-readable media containing instructions for executing functionality of the one or more components and a processor for executing the functionality.

In some embodiments, the system is coupled to each of the vehicles over a cloud network. In some embodiments, the vehicle simulator includes an array of vehicle data structures, each vehicle data structure corresponding to a vehicle from the fleet of vehicles. Each vehicle data structure includes a state or charge of the vehicle.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 is a block diagram of a system for assigning vehicles from a fleet of vehicles to optimally handle service requests in accordance with some embodiments.

FIG. 2 is a flow chart of the steps assigning vehicles from a fleet of vehicles to optimally handle service requests in accordance with some embodiments.

FIG. 3 shows a flow and corresponding components for assigning vehicles from a fleet of vehicles to optimally handle service requests in accordance with some embodiments.

FIG. 4 is an exemplary module for processing in accordance with some embodiments.

### DETAILED DESCRIPTION OF THE EMBODIMENTS

In accordance with embodiments of the disclosure, vehicles in a fleet of vehicles are allocated to service requests. The requests may be to pick up a ride sharing fare, respond to a request to meet a customer and change a tire or charge a battery, transport materials to a location on a constructions site, or deliver a part to a location in a warehouse, to name only a few examples. The request may be serviced by a vehicle controlled by a human operator or by an automated system, such as an automated vehicle (AV) or a robot. The vehicles are dispatched to service the requests to optimize one or more selected criteria, such as minimizing wait (response) time, minimizing charge expended, reducing cost, reducing environmental impact, and reducing wear and tear on the vehicles, to name only a few examples. In some embodiments, the system leverages traffic data, weather conditions, and historical patterns to accurately predict travel time from origin to destination, energy consumption for electric vehicles (EVs), ensuring that vehicles have sufficient charge to complete assignments (e.g., service requests) without disruptions. Using this information, vehicles can be assigned to service requests so that the vehicles in a fleet are in combination utilized more efficiently.

In some embodiments, the system dynamically allocates (assigns) vehicles to service requests and charging stations by considering the proximity of available vehicles to service requests, service urgency and prioritization, current battery levels and estimated remaining service capacity, charger availability and expected wait times, operator availability (e.g., a human operator is required by law to take a minimum number of breaks at specific time intervals and may not be available to service the request). The vehicle assignment schedule may change in real time, given changing conditions. Typically, the factors change in real time, requiring the optimization algorithms to produce outputs that also change in real time.

In some embodiments, the system includes a Cost-to-Go Learning Framework. Using this Framework, a value function is derived from historical data and past decisions. The system is thus able to evaluate the long-term impact of each assignment decision on fleet efficiency and cost; continuously refine strategies through machine learning techniques; and improve the future assignments by minimizing operational costs while maximizing service efficiency.

The system receives data from various sources to facilitate optimal decision-making for fleet dispatch and service assignments. In some embodiments, the input categories include service requests, contextual data, fleet and depot status, vehicle status, and historical data. The system generates key performance indicators (KPIs) related to the parameter(s) to be optimized. Each of these is discussed below:

### Service Requests

In some embodiments, service requests define the operational demand placed on the system and provide real-time inputs to trigger fleet deployment. In some embodiments, key parameters include:
Request Timestamp; Indicates when the service request was initiated
Service Type: Classification of the service needed, which may include:
   Light services: Jump starting, lock-out assistance, tire replacement, etc.
   Heavy-duty services: Towing, battery charging, extensive roadside assistance, etc.
Request Location: Latitude and longitude of the services location
Urgency Level: Priority level based on customer needs or safety concerns

### Contextual Data

Contextual data refers to external factors that may impact service delivery. In some embodiments, contextual data include traffic conditions, such as real-time traffic data to assess congestion levels to thereby estimate arrival times at the service location, and environmental conditions, such as weather and temperature, which may affect vehicle performance, road safety, and estimated service durations. Contextual Intelligence is described in U.S. patent application Ser. No. 17/525,318, filed Nov. 12, 2021, and titled “Systems for and Methods of Real-Time Contextual Intelligence for Context-Aware Smart E-Mobility,” which is hereby incorporated by reference in its entirety.

### Fleet and Depot Status

This dataset provides an overview of fleet capabilities and depot infrastructure, including:
Number of electric vehicles (EVs): total EVs in operation and their availability
Number of depots: Locations where vehicles can be stationed, refueled, or recharged
Vehicle Charging Specifications: Battery capacity, charging speed, and compatibility with different charging infrastructures
Number of Charging Stations: Available charging points at each depot and their real-time occupancy status
Depot Locations: Geographical distribution of depots to facilitate optimal service coverage

### Vehicle Status

The system maintains real-time tracking and diagnostics for each vehicle:
Vehicle Location: GPS-tracked position of each vehicle (latitude/longitude).
Vehicle Speed: Current velocity for real-time monitoring and safety considerations
State of Charge (SOC): Battery levels of EVs to determine feasibility of assignments (e.g., servicing requests)
Remaining Shift Time: Work Schedule constraints of drivers, ensuring compliance with regulations and fatigue management

### Historical Data

In some embodiments, the system leverages historical service patterns to enhance predictive capabilities:
Temporal Distribution of Services: Identifying peak demand hours to proactively allocate resources. For example, dispatching vehicles to a stadium during game day before any requests are made.
Geographical Distribution of Services: Understanding regional demand variations to optimize depot and fleet positioning. For example, giving requests a lower priority when the destination is in a rural area, where additional revenue-generating service requests are unlikely. This situation may result in an increased the cost-to-go.
Service Duration Statistics: Analyzing the average time taken for different service types to refine operational efficiency

### System Output

The system's intelligent dispatch mechanism generates optimized outputs based on real-time data and predictive analytics.

### Key Performance Indicators (KPIs)

The system continuously optimizes and tracks key operational metrics, such as:
Average Service Response Time: Measuring efficiency in responding to service requests
Average EV Utilization Rate: Monitoring the effective deployment and workload of EVs
Average Internal Combustion Vehicle (ICV) Utilization Rate: Tracking conventional fleet usage
Operational Costs: Breaking Down expenditures into categories:
   Fuel/Gas Costs: Monitoring fuel consumption for cost-effective routing
   Vehicle Purchase & Depreciation: Managing long-term fleet investments
   Diver Labor Costs: Optimizing scheduling to minimize unnecessary labor expenses (e.g., if customer wait time is not increased significantly, assign to vehicle whose driver is not at overtime rate)
   Maintenance Costs: Predicting and reducing vehicle downtime through proactive maintenance scheduling

KPIs measure and optimize system efficiency.

### Solution Formulation

### Given Inputs

1. Parameters of the service distribution
   a. Time
   b. Location
   c. Duration
2. Parameters of the environment
   a. Traffic congestion level
   b. Weather/Temperature
3. Parameters of the fleet
   a. Number of electric vehicles
   b. Vehicle charging specs
   c. Number of charging stations
   d. Number of depots
   e. Locations of depots
4. Initial states of vehicles
   a. Initial locations
   b. Initial SOCs

### And Final KPIs to Optimize

1. Average service response time
2. Average EV utilization rate
3. Average ICV utilization rate
4. Cost of operation
   a. Gas
   b. Vehicle purchase
   c. Driver
   d. Maintenance

In some embodiments, these KPIs are tracked to provide inputs to update the assignment algorithms based on real-time data.

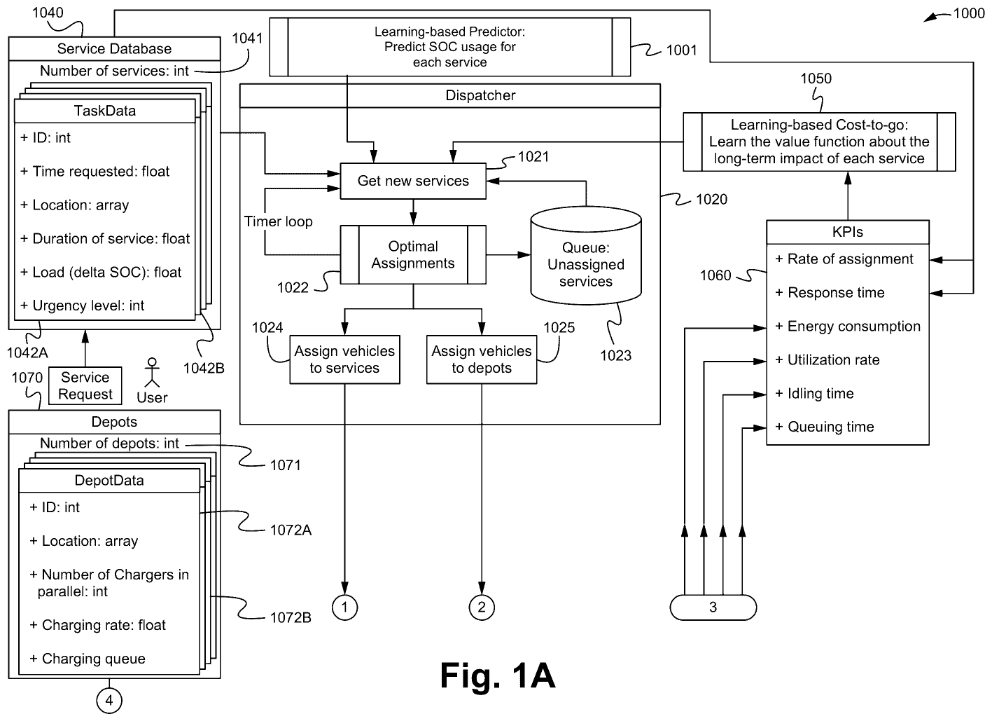

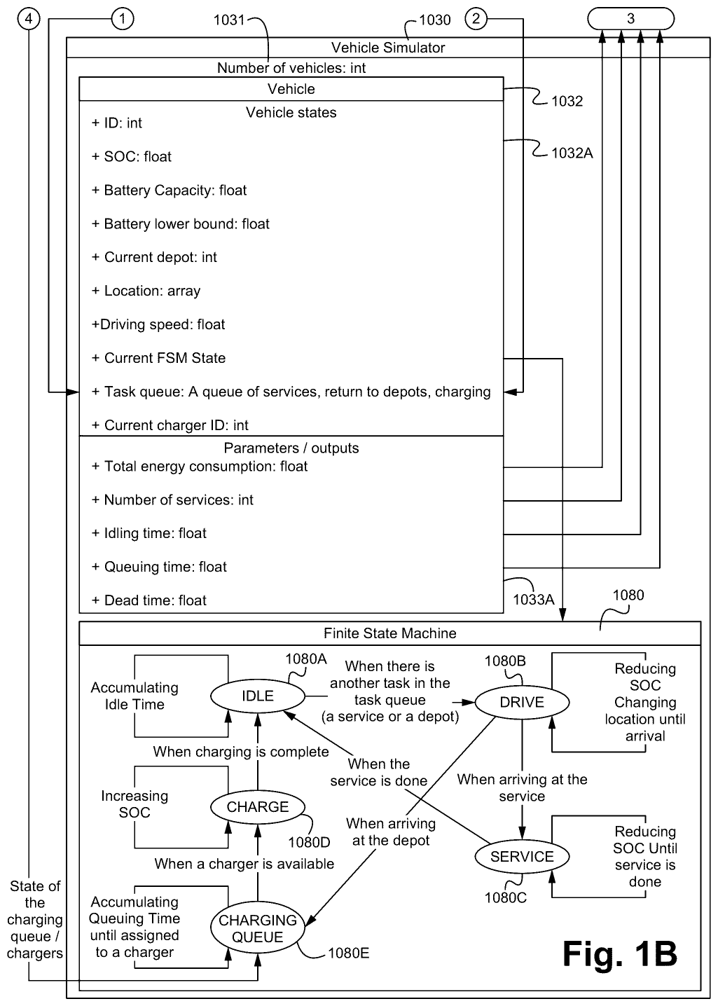

FIG. 1 is a block diagram of a system 1000 for optimizing fleet assignment in accordance with some embodiments. The system 1000 includes a Learning-Based Predictor (LBP) 1001; a Dispatcher 1020; a Vehicle Simulator 1030; a Service Database 1040; a Learning-Based Cost to Go (LBCG) module 1050, a KPIs module 1060, and a Depots module 1070.

The Dispatcher 1020 includes a Get New Services trigger 1021, an Optimal Assignment module 1022, a Queue Database 1023 that stores a queue of unassigned services, an Assign Vehicles to Services trigger 1024, and an Assign Vehicles to Depots trigger 1025. The Get New Services module 1021 is coupled to and receives triggers from one or more of the LBP 1001, the Optimal Assignment module 1022, the Queue Database 1023, the Service Database 1040, and the LBCG module 1050. Once the Get New Services trigger 1021 is activated, by, for example, an update to the Service Database 1040, the Optimal Assignment module 1022, generates an updated assignment schedule (if needed) to service tasks. In some embodiments, the Optimal Assignment module 1022 itself generates an input to the Get New Services trigger 1021 at timed intervals (e.g., predetermined or variable) to thereby generate an updated optimal assignment based on updated criteria. The Optimal Assignment module 1022 is coupled to and generates outputs to the Queue Database 1023, the Assign Vehicles to Services module 1024, and the Assign Vehicles to Depot module 1025.

The Services Database 1040 stores a Number of Services 1041 (int) and an array of Task Data data structure 1042A, B, . . . , Z. The illustrative Task Data data structure 1042A includes an ID (int), a Time Requested (float), a Location (Array), a Duration of Service (float), a Load (delta SOC) (float), and an Urgency Level (int), with parentheticals here, and the following discussion, showing the data type. In operation, a user makes a service request, with the system automatically populating the Service Database 1040. This request generates an input from the Services Database 1040 to the Get New Services module 1021 in the Dispatcher 1021, triggering the Optimal Assignment module 1022 to update the assignments based on the changed circumstances (e.g., a new service to be performed).

The LBCG module 1050 is coupled to the KPIs module 1060, which stores and transmits to the LBCG module 1030 the elements of a data structure including Rate of Assignment, Response Time, Energy Consumption, Utilization Rate, Idling Time, and Queuing Time, each discussed in more detail below. The LBCG module 1030 uses the values in the KPIs data structure 1060 to learn the value function about the long-term impact of each service. When the value function meets certain criteria, the LBCG module 1030 triggers the Get New Services module 1021. As explained below, the KPIs module 1060 receives as inputs one or more Parameters/Outputs from the Vehicle Simulator module 1033A-Z. The KPIs module 1060 is also coupled to and receives inputs from the Service Database 1040.

The Vehicle Simulator 1030 includes an integer indicating the number of vehicles in the fleet, an array of Vehicle entries 1031A-1031Z (to simplify the drawing, only illustrative entry 1031A is shown), each corresponding to one of the vehicles in the fleet, and a finite state machine (FSM) 1080. The illustrative Vehicle entry 1031A includes a Vehicle States data structure 1032A and a Parameter Outputs data structure 1033A. The Vehicle States data structure 1032A includes an ID (integer), an SOC (float), a Battery Capacity (float), a Battery Lower Bound (float), a Current Depot (int), a Location (array), a Driving Speed (float), a Current FSM State (float), a Task Queue (e.g., a queue of services, return to depot, charging), and a Current Charger ID (int). The Parameters/Outputs data structure 1033A includes a Total Energy Consumption (float), a Number of Services (int), an Idling time (float), and a Dead Time (float). It will be appreciated by those skilled in the art that the elements in the data structures 1032A and 1033A are merely illustrative. In other embodiments, other elements can be added to the data structures 1032A and 1032B, some elements can be deleted, or both.

The Finite State Machine (FSM) 1080 includes an Idle State 1060A, a Drive State 1080B, a Service State 1080C, and a Charging Queue State 1035E. If the FSM 1080 is in the Idle State 1080A, when there is another task in the task queue (a service or a depot), the FSM 1080 transitions to the Drive State 1080B. Otherwise, the Idle State loops on itself, accumulating idle time. When in the Drive State 1080B, if the corresponding vehicle arrives at the service, the FSM 1080 transitions to the Service State 1080C. If, in the Drive State 1080B, the vehicle arrives at the depot, the FSM 1080 transitions to the Charging Queue State 1080E. If, in the Drive State 1080B, the vehicle is still in route to its destination (request location, e.g., customer, construction site location, factory floor, etc.), reducing SOC, the Drive State 1080B loops back on itself until the destination is reached.

In the Service State 1080C, when the service is completed, the FSM 1080 transitions to the Idle State 1080A. If the service is not yet completed, the FSM 1080 loops back on the Service State 1080C, reducing the SOC until the service is completed.

In the Charging Queue State 1080E, when a charger is available, the FSM 1080 transitions to the Charge State 1080D. Otherwise, the FSM 1080 loops in the Charging Queue State 1080E, accumulating queueing time until the vehicle is assigned to a charger. When the FSM 1080 is in the Charging Queue State 1080E, the Depots module 1070 is updated with the state of the Charging Queues and the chargers.

In the Charge State 1080D, when charging is complete, the FSM 1080 transitions to the Idle State 1080A. Otherwise, while the SOC is increasing, the Charge State 1080D loops back on itself.

In some embodiments, one or more of the LBP 1001, the Dispatcher 1020, the Vehicle Simulator 1030, the System Database 1040, the LPCG 1050, the KPIs 1060, and the Depots 1070 includes computer-readable media storing computer-executable instructions for carrying out the component's functionality and one or more processors for executing those instructions.

In some embodiments, the elements of the system 1000 are distributed across multiple platforms. In some embodiments, all the components 1001, 1020, 1030, 1040, 1050, 1060, and 1070 are stored in the cloud. In some embodiments, the elements are stored redundantly on vehicles and on a cloud network, so that if the cloud connection is lost, the system still functions. Once the cloud connection is restored, the elements on each vehicle are updated to reflect, for example, the data corresponding to the remaining vehicles in the fleet.

It will be appreciated by those skilled in the art that the elements of the system 1000 are merely illustrative. For example, some embodiments do not include the LBCG 1030.

The components of the system 1000 are now described in more detail.

### System Components in Detail

### Service Database

The Service Database stores incoming service requests and their attributes, including demand patterns. The Service Database contains:
Number of Active Service Requests
Task Data Attributes:
   ID: Unique identifier for each service request.
   Time Requested: Timestamp indicating when the request was made.
   Location: Geographic coordinates (latitude/longitude) of the request.
   Duration of Service: Estimated time to complete the requested task. This can be used when predicting when a vehicle may become available, where delay between receiving a request and becoming available is approximately response time+duration of service
   Load (Delta SOC): Predicted battery consumption for the service based on criteria such as the amount of charge that must be delivered to recharge a battery, the weight of a car that must be towed, the slope of a hill along the route to the towing destination, etc.
Urgency Level: Priority indicator for service fulfillment. May be used, for example, to service a request even though doing so is not optimal use of the system.

When a user submits a service request, the request is logged into the database, awaiting dispatch.

### Dispatcher

The Dispatcher handles task assignment and vehicle dispatch. It is the central decision-making unit responsible for allocating fleet resources efficiently. It comprises:
Queue of Unassigned Services: Stores pending service requests waiting for assignment.
Optimal Assignment Module:
   Matches vehicles to service requests.
   Assigns vehicles to depots for charging when necessary.
Timer Loop: Regularly checks for new service requests and updates assignments accordingly.

The Dispatcher optimally assigns vehicles based on battery levels, location, service urgency, and fleet availability.

### Learning-Based Predictor

The Learning-Based Predictor predicts energy consumption (e.g., SOC usage) usage for each service trip. This helps in:
Preventing vehicle battery depletion to drive to different service locations and return to the nearest depot afterwards

In some embodiments, the Learning Based Predictor also predicts the next service to be requested. By integrating machine learning models, this component enhances the efficiency and reliability of dispatch decisions.

### Learning-Based Cost-to-Go

The Learning-Based Cost-to-Go (LBCG) module continually improves decision-making based on long-term performance. The LBCG module 1050 predicts state of charge (SOC), and learns the value function about the long-term impact of each service, thereby allowing the system to be optimized according to optimization criteria, such as key performance indicators (KPIs). It applies a learning approach to optimize long-term operational efficiency. This module:
Learns a value function that estimates the long-term impact of each assignment decision.
Improves fleet routing and dispatching based on historical assignments.
Balances short-term efficiency vs. long-term strategic decision-making.

Over time, the system refines its assignment strategy, reducing:
Energy consumption.
Service response time.
Operational costs (fuel, maintenance, labor).

### Vehicle Simulator

The Vehicle Simulator tracks real-time vehicle status and state transitions. It monitors and updates real-time fleet information, including:
Total Number of Vehicles in the System
Vehicle Attributes:
   ID: Unique vehicle identifier.
   SOC: Current battery charge level.
   Battery Capacity: Maximum energy storage.
   Battery Lower Bound: Minimum SOC before requiring recharging.
   Current Depot: Assigned depot location.
   Location: GPS coordinates.
   Driving Speed: Current velocity.
   Current FSM State: Operational status (Idle, Drive, Service, Charge).
   Task Queue: List of assigned tasks (services, charging, depot returns).
   Current Charger ID: Assigned charger (if applicable)
Performance Metrics Monitored:
   Total Energy Consumption per vehicle.
   Number of Services Completed.
   Idling Time (time spent inactive).
   Queuing Time (time spent waiting for a task or charger).
   Dead Time (inefficient non-productive time).

The Vehicle Simulator ensures realistic tracking of vehicle performance and operational constraints.

### Depots

Depots manage vehicle charging and parking. Depots serve as charging hubs and fleet parking stations. Each depot maintains:
Number of Depots: Total available locations.
Depot Data Attributes:
   ID: Unique depot identifier.
   Location: GPS coordinates.
   Number of Chargers in Parallel: Maximum simultaneous charging capacity.
   Charging Rate: Energy replenishment speed.
   Charging Queue: List of vehicles waiting for charging.

When vehicles run low on battery charge, the system assigns them to available depots based on location and charger availability.

### Finite State Machine (FSM)

The FSM models vehicle behavior, defining possible states and transitions:
1. IDLE:
   The vehicle is inactive and accumulating idle time.
   Transitions to DRIVE when assigned a new service or depot task.
2. DRIVE:
   The vehicle is traveling to a service location or depot.
   Battery SOC decreases as energy is consumed.
3. SERVICE:
   The vehicle is actively servicing a request.
   SOC continues to deplete until completion.
4. CHARGING QUEUE:
   The vehicle is waiting for an available charger.
   The vehicle accumulates queuing time until assigned.
5.CHARGE:
   The vehicle charges at the depot, replenishing SOC.
   Transitions back to IDLE or DRIVE when fully charged.

This FSM structure ensures a clear workflow for fleet operations.

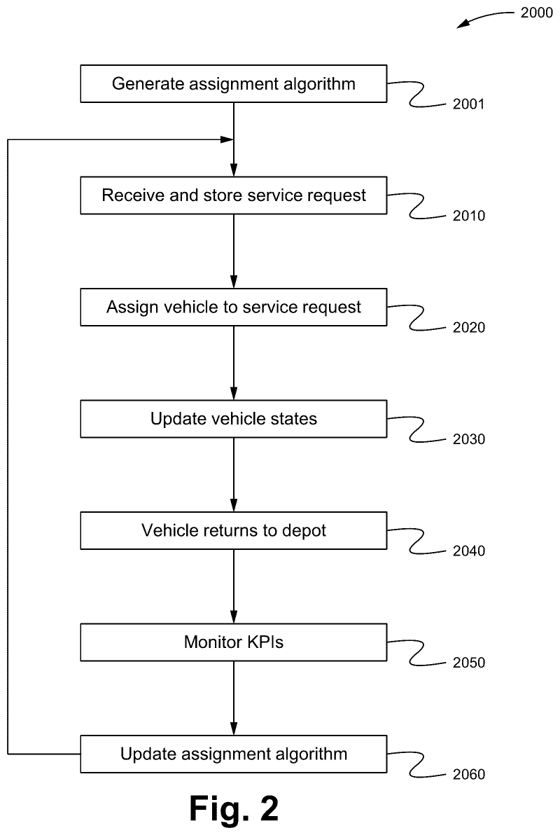

FIG. 2 is a flow chart showing the steps 2000 of a method to optimize the assignment of vehicles to fulfill service requests in accordance with some embodiments. Referring to FIGS. 1 and 2 merely for explanation of one embodiment, in a step 2001, an assignment algorithm is generated based on input from the LBP 1001 and the LBCG 1050. Next, in a step 2010, a service request is received by the Dispatcher 1020 from a user and stored in the Service Database 1040, thereby ultimately triggering an Optimal Assignment 1022 (triggered via the Get New Services 1021). The Dispatcher 1020 uses the LBP 1001 to estimate SOC usage. In a step 2020, the Optimal Assignment module 1022 assigns vehicles to service requests, and updates the task queues of each vehicle. The vehicles are assigned to service the request based on learning algorithms that predict the assignment that will optimize fleet usage based on certain criteria. The vehicles are then dispatched to service the requests. In a step 2030, the Vehicle Simulator 1030 updates the status of the vehicles by tracking real-time movement and SOC depletion. The FSM 1080 dictates vehicle behavior as the vehicles transition between the Idle, Drive, Service and Charge states. In a step 2040, the vehicles return to the depot, where they recharge or wait in a charging queue. In a step 2050, the KPIS are monitored, transmitted to the KPI module 1060, and used by the LBGC 1050 to improve/optimize assignments.

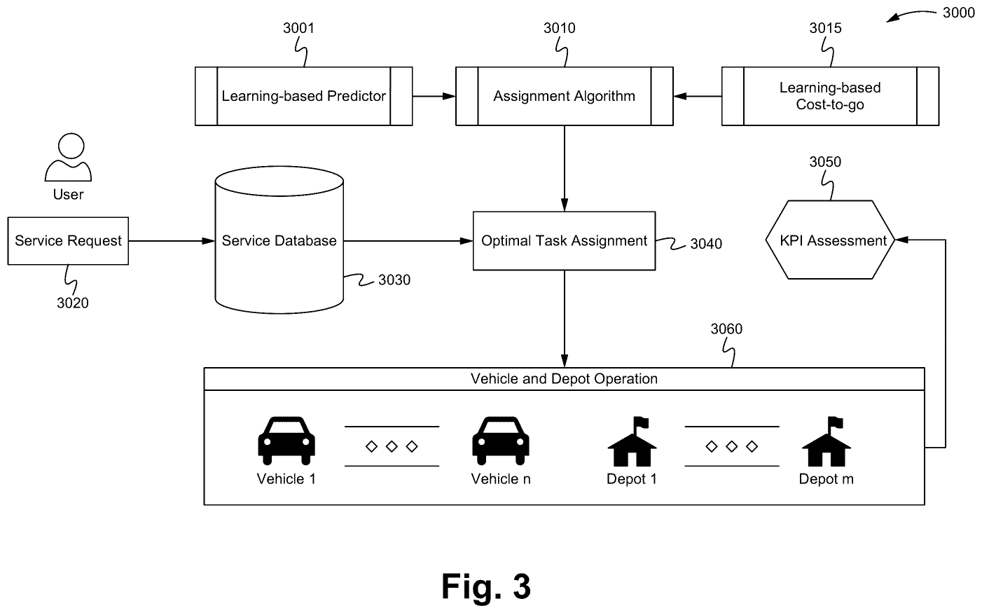

FIG. 3 is a high-level flow chart of a workflow 3000 for optimally managing a fleet of vehicles in accordance with some embodiments. As shown in FIG. 3, an Assignment Algorithm 3010 receives inputs from a Learning Based Predictor 3001 and a Learning Cost to Go module 3015. The Assignment Algorithm 30101 triggers an Optimal Task Assignment 3040, which receives input from a Service Database 3030, which in turn receives a service request from a User 3020. The Optimal Task Assignment assigns vehicles 3060 to services and to a Depot with charging stations. The results of the assignment are collected in KPI Assessment 3050 and are used by the LBCG module 1050 to measure the efficiency of the assignment algorithm and update it to optimize felt usage.

The assignment strategy is determined by formulating and solving a model predictive control (MPC) problem that periodically assigns vehicles to charging, services, or stay. The decision variable includes the assignment of vehicles to different tasks, where the vehicles in the “IDLE” state are considered. In some embodiments, the hard constraints include:
1. SOC Constraints: The vehicles need to have enough power to finish the service and return to the nearest depot.
2. Service Constraints: Each service can only be executed by at most one vehicle (o means that no one takes it).
3. Vehicle constraints: Each vehicle has to be assigned to one task (service, depot, or stay.
4. Stays constraints: If the vehicle is going to stay, it can only stay at the current location.

The costs include:
1. Time consumption of going to tasks
2. Cost-to-go
   a. Based on all input parameters above to predict the cost for future dispatching.
   b. Use a learning based model to approximate this cost (optional).
   c. Account for the curse of dimensionality.
      i. Use coarse discretization.
      ii. Fit a fixed-form function rather than an unknown network.

Next, the policy is formulated:

### Optimal Assignment Policy Formulation

In some embodiments, an optimization problem is formulated. The optimization problem periodically assigns vehicles to
1. Depots (to join the queue and charge) [symbol] d
2. Services [symbol] s
3. Stay in-place [symbol] ₐ

The vehicles to consider [symbol] v include all vehicles that are operating and not queuing or charging.

### Optimization Problem Overview

Assignment Policy with Cost-to-go

$$\begin{matrix}{min}_{X} & {\sum }_{i ∈ {ℐ}_{V}} {\sum }_{j ∈ {ℐ}_{s} ⋃ {ℐ}_{d} ⋃ {ℐ}_{a}} {X}_{i , j} {C}_{i , j} \\ s . t . & {X}_{i , j} ∈ \{ 0 , 1 \} , ∀ i ∈ {ℐ}_{V} , j ∈ {ℐ}_{s} ⋃ {ℐ}_{d} ⋃ {ℐ}_{a} \\ & {\sum }_{i ∈ {ℐ}_{V}} {X}_{i , j} \leq 1 , ∀ j ∈ {ℐ}_{s} \\ & {\sum }_{j ∈ {ℐ}_{s} ⋃ {ℐ}_{d} ⋃ {ℐ}_{a}} {X}_{i , j} = 1 , ∀ i ∈ {ℐ}_{V}\end{matrix}$$

$$\begin{matrix}{X}_{i , j} = 0 , ∀ i ∈ {ℐ}_{V} , j ∈ {ℐ}_{a} , i = j \\ {X}_{i , j} * ( {SOC}_{i} - {D}_{i , j} ) \geq 0 , ∀ i ∈ {ℐ}_{V} , j ∈ {ℐ}_{s} ⋃ {ℐ}_{d}\end{matrix}$$

where the decision variable x_{i,j} encodes the assignment of vehicles to different tasks. X_{i,j}=1 means the vehicle I will be assigned to task 1.

Minimizing the above equation (1) with the constraints and cost functions below will generate an optimal assignment. After reading this disclosure, those skilled in the art will recognize other methods and equations to optimize an assignment policy in accordance with the embodiments.

Optimization using KPIs is disclosed in U.S. patent application Ser. No. 18/635,529, filed Apr. 15, 2024, and titled “Systems for and Methods of Increasing Electric Vehicle Utilization in Transit Fleets Using Learning, Predictions, Optimization, and Automation,” which is hereby incorporated by reference in its entirety.

### Constraints

The hard constraints include

$${\sum }_{i ∈ {ℐ}_{V}} {X}_{i , j} \leq 1 , ∀ j ∈ {ℐ}_{s}$$

means that each service can only be executed by at most 1 vehicle from [symbol] _{V}

$${\sum }_{j ∈ {ℐ}_{s} ⋃ {ℐ}_{d} ⋃ {ℐ}_{a}} {X}_{i , j} = 1 , ∀ i ∈ {ℐ}_{V}$$

means that each vehicle has to be assigned to one task (a service, a depot, or stay).

X_{i,j}=0, ∀i∈ [symbol] ᵥ,j∈ [symbol] ₐ,i=j means that it is not possible to assign vehicle i to some other vehicle's location. Each vehicle can only stay in-place at its own location.

X_{i,j}*(SOCᵢ−D_{i,j})≥0, ∀i∈ [symbol] ᵥ,j∈ [symbol] ₛ∪ [symbol] _{d} means that the vehicle i has to have enough energy to drive to this task & return to a nearest depot afterwards. The current battery level is SOCᵢ and the task j requires D_{i,j} energy. D_{i,j} is estimated by the “Learning-based Predictor”.

### Cost Function

$${C}_{i , j} = {w}^{𝔱} {c}_{i , j}^{time} + {w}_{j}^{soc} ( {SOC}_{i} - {D}_{i , j} - {SOC}_{l b} ) - {r}_{j} + {𝔼}_{i , j}$$

where,
The first term w^{t}c_{i,j}^{time} describes the cost of spending time c_{i,j}^{time} for vehicle i to conduct service j. w^{t} is a tunable weight
The second term wⱼ^{soc}(SOCⁱ−D_{i,j}−SOC_{lb}) describes the cost of spending energy D_{i,j} to conduct service j. SOCᵢ is the current battery level of vehicle i, SOC_{lb} is a battery level lower bound. wⱼ^{soc} is a tunable weight
rⱼ describes the reward of taking task j. The type and the urgency of a task will impact the value of rⱼ. For example, going back to depot will have a small reward, while taking an urgent service will receive a big reward.
[symbol] _{i,j} is the learned cost-to-go for vehicle i and task j. Based on the detailed implementation, this might be a function with different input features.
   Heuristics can be chosen if learning is hard to implement. One possible option is model [symbol] _{i,j}=: w^{future} [symbol] ⱼ(d,T), which is the expected number of upcoming services around the location of task j, d is the distance radius to consider, T is the future time horizon, and w^{future} is a tunable parameter

In some embodiments, Equation (1) is calculated according to predefined criteria: As some examples, (a) the “minimal” value is computed by limiting the maximum computation time for each problem being solved, thereby generating assignments more quickly or (b) a frequency at which the “timer loop” runs (i.e. every 10s or every 5 minutes) is selected to solve the optimization function. This frequency can be selected during system initialization or can be continually adjusted during system operation to meet certain requirements. After reading this disclosure, those skilled in the art will recognize other ways in which an optimization problem in accordance with the embodiments is solved.

Because embodiments optimize assignments by minimizing costs for a constrained system, some embodiments are directed to a model predictive control (MPC) system.

In operation, systems and methods optimally dispatch vehicles from a fleet of vehicles to service requests in a way that optimally meets certain criteria, such as reducing customer wait time, minimizing total fleet energy consumption, reducing environmental impact, increasing fleet utilization, distributing the assignments evenly across the vehicles to reduce vehicle wear and tear, and meeting labor laws, to name only a few examples. Initially, a simulator is built. The simulator simulates service processes and charging processes based on the assignment strategy. As service requests come in, the requests are assigned to the vehicles based on dynamically updated optimal assignment strategy. The strategy/algorithm can be updated to account for updated entries in the Service Database 1040, updates to the context, updates to the availability of vehicles, to name a few factors. The vehicles statuses, charges, and response times, to name a few variables, are tracked to determine KPIs. The KPIs are used to update the assignment strategy for more optimal results. The service requests are monitored to determine new requests and requests that have been serviced, to keep the system current.

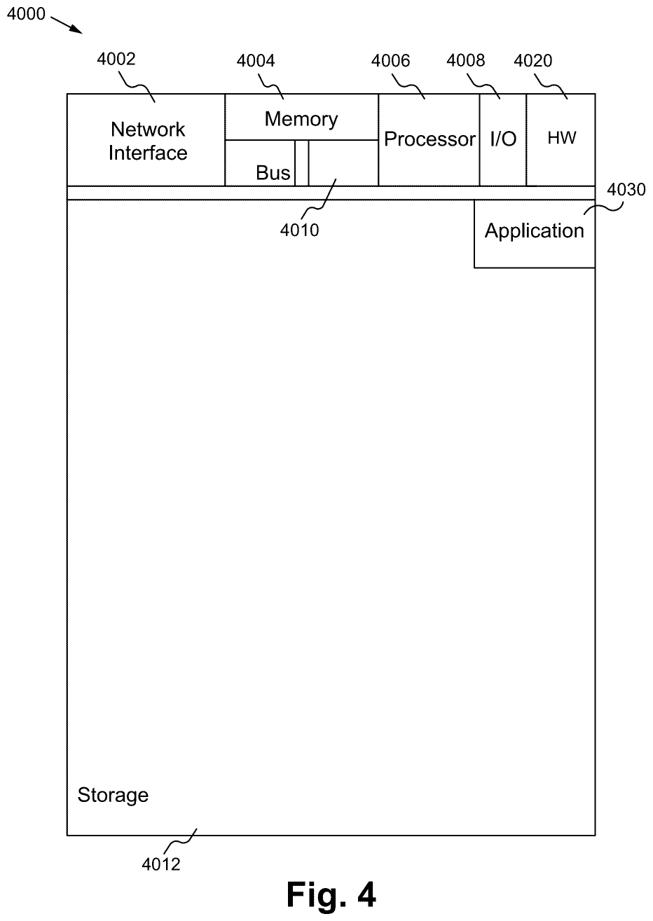

FIG. 4 shows a block diagram of an exemplary computing device/module 4000 configured to implement the components of the system 1001. It will be appreciated that each of the components 1001, 1020, 1030, 11040, 1050, 1060, and 1070 are able to be distributed across one or multiple computing devices 4000, in any combination. As one example, the LBP 1001, the LBCG 1050, the Vehicle Simulator 1030, the Services Database 1040, and the Depots module 1070 are each hosted on a separate device 4000. In other embodiments, the LBP 1001 and the Vehicle Simulator 1030 are contained on a single device 4000. The computing device 4000 is able to be used to acquire, store, compute, process, communicate and/or display information. In general, a hardware structure suitable for implementing the computing device 4000 includes a network interface 4002, a memory 4004, a processor 4006, I/O device(s) 4008, a bus 4010 and a storage device 4012. The choice of processor is not critical as long as a suitable processor with sufficient speed is chosen. The memory 4004 is able to be any conventional computer memory known in the art. The storage device 4012 is able to include a hard drive, CDROM, CDRW, DVD, DVDRW, High Definition disc/drive, ultra-HD drive, flash memory card or any other storage device. The computing device 4000 is able to include one or more network interfaces 4002. An example of a network interface includes a network card connected to an Ethernet, other type of LAN, or a cloud network, to name only a few examples. The application(s) 4030 are used to implement the functionality of the modules, such as optimal assignment generation (1022), Learned-Based Predictor applications (1001), Vehicle Simulation (1030), Service Database (1040), Learning-Based Cost-to-Go Operations (1050), and Depots (1070), to name only a few examples. More or fewer components shown in FIG. 4 are able to be included in the computing device 4000. Although the computing device 4000 in FIG. 4 includes applications 4030 and hardware 4020, processing is able to be implemented on a computing device in hardware, firmware, software or any combination thereof. For example, in some embodiments, optimal assignment processing is programmed in a memory and executed using a processor. In another example, in some embodiments, the processing is programmed in hardware logic including gates specifically designed to implement the functionality.

While FIG. 4 shows several components of a computing device, it will be appreciated that more or fewer components can be used to implement the embodiments.

The embodiments are able to be modified in many ways in accordance with the principles of the embodiments. For example, while the examples above discuss assigning vehicles from a fleet of electric vehicles, it will be appreciated that the principles of the embodiments can be applied to other vehicles such as internal combustion vehicles, hybrids, automated vehicles, and robots, to name only a few examples. And while the illustrative flow charts show sequences of steps, in other embodiments, some steps can be added, some deleted, and some performed in different orders, to name only a few modifications. After reading this disclosure, those skilled in the art will recognize other modifications and uses.

It will be readily apparent to one skilled in the art that various other modifications may be made to the embodiments without departing from the spirit and scope of the invention as defined by the appended claims.

We claim:

1. A method of optimally assigning on-demand vehicles in a fleet of vehicles comprising:
collecting real-time data for vehicles in the fleet of vehicles;
simulating service and charging processes for the vehicles;
determining assignment strategies for the vehicles to service one or more service requests through model predictive control (MPC); and
adjusting assignments based on cost-to-go predictions from a deep reinforcement learning (DRL) model.

2. The method of claim 1, wherein the data comprise telematics data, operational data, context, or any combination thereof.

3. The method of claim 1, wherein the fleet of vehicles comprises electric vehicles.

4. The method of claim 1, wherein the fleet of vehicles comprises automated vehicles, human-operated vehicles, or both.

5. The method of claim 1, wherein the assignment strategies are determined through model predictive control.

6. The method of claim 1, wherein the cost-to-go predictions are determined from a deep reinforcement learning model (DRL).

7. The method of claim 6, wherein the DRL model evaluates an effectiveness of different vehicle assignment strategies under varying operational conditions.

8. The method of claim 1, wherein the assignments are based on an assignment algorithm, wherein adjusting the assignments comprises solving an optimization problem.

9. The method of claim 8, wherein the optimization problem has associated constraints, costs, or both.

10. The method of claim 9, wherein the cost-to-go predictions are based on a cost-to-go model that incorporates one or more factors comprising vehicle state of charge (SOC), traffic conditions, and predicted service demand.

11. The method of claim 10, wherein the constraints and cost-to-go include driver status and labor rules so that the assignment maximizes driver utilization while meeting the labor rules.

12. The method of claim 10, wherein the factors comprise context, the context comprising traffic conditions, weather conditions, a frequency of past service requests within a predetermined distance of a customer location, or any combination thereof.

13. A system for optimizing on-demand fleet operations for a fleet of vehicles, the system comprising:
a learning-based predictor (LBP) configured to predict energy consumption usage for each vehicle in the fleet of vehicles for service trips;
a dispatcher coupled to the LBP, the dispatcher configured to receive service requests and assign the service requests to the vehicles to optimize parameters for servicing the service requests;
a learning-based cost-to-go (LBCG) module coupled to the LBP and the dispatcher, the LBCG module configured to maximize long-term performance of the fleet of vehicles for the service trips; and
a vehicle simulator coupled to the dispatcher and the LBCG, the vehicle simulator configured to simulate the functioning of the vehicles and transmit output and parameters to the LBCG.

14. The system of claim 13, further comprising a service database storing service requests, the service database coupled to the dispatcher, such that when a service is added to or deleted from the service database, the optimal assignment module is updated.

15. The system of claim 14, further comprising a queue database storing unassigned services, wherein entries in the queue database trigger updating the optimal assignment module.

16. The system of claim 15, wherein the vehicle simulator generates key performance indicators transmitted to the LBCG.

17. The system of claim 16, further comprising a Depot module coupled to the vehicle simulator, the Depot module configured to store states of charging queues and states of charging in a depot.

18. The system of claim 17, wherein the vehicle simulator comprises a finite state machine for monitoring transitions between states for the vehicles, the states comprising one or more of IDLE, DRIVE, SERVICE, CHARGE, and CHARGING QUEUE.

19. The system of claim 13, wherein one or more of components comprising the LBP, the dispatcher, the LBGC, and the vehicle simulator comprises a corresponding computer-readable media containing instructions for executing functionality of the one or more components and a processor for executing the functionality.

20. The system of claim 13, wherein the system is coupled to each of the vehicles over a cloud network.

21. The system of claim 13, wherein the vehicle simulator comprises an array of vehicle data structures, each vehicle data structure corresponding to a vehicle from the fleet of vehicles, each vehicle data structure comprising a state or charge of the vehicle.
